(19) United States
(12) Patent Application Publication
(10) Pub. No.: US 2017/0061851 A1
(43) Pub. Date: Mar. 2, 2017

(54) LARGE GAMUT PIXEL AND SUBTRACTIVE MASK FOR A VISUAL PRESENTATION

(71) Applicant: Hewlett-Packard Development Company, L.P., Houston, TX (US)

(72) Inventors: Peter MOROVIC, Sant Cugat del Valles (ES); Jan MOROVIC, Colchester (GB); David A. FATTAL, Mountain View, CA (US); Marco FLORENTINO, Mountain View, CA (US)

(21) Appl. No.: 15/307,693

(22) PCT Filed: Apr. 30, 2014
(86) PCT No.: PCT/US2014/036094

§ 371 Date: Oct. 28, 2016

(51) Int. Cl. G09G 3/20; G09G 3/34

(52) U.S. Cl. CPC G09G 3/2044; G09G 3/3413; G09G 2320/0666; G09G 2300/0452

(57) ABSTRACT

A pixel source for a visual presentation is disclosed. The pixel source can include a light source, a large gamut pixel, a subtractive mask, and a control input to control the subtractive mask. A display device is also disclosed comprising a light source array with a large gamut pixel array and subtractive mask array disposed thereon. In operation, wide-band light emitted from each light source can be modulated by each large gamut pixel to output a plurality of primary colors. Each subtractive mask can be controlled to block, partially transmit, or fully transmit any number of the outputted primary colors to produce color points that can be interpolated and half-toned to output a large gamut of secondaries for each pixel.

### BACKGROUND

Manufacturers of display devices continue to seek greater image quality. Previous methods to bolster image quality include the use of liquid crystals, light emitting diodes, and plasma in conjunction with various control techniques to further increase image resolution and color gamut.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1A is an example of a display device with a large gamut pixel/subtractive mask array controlled by an enhanced pixel control system;

FIG. 1B is an example schematic depiction of a pixel source for a display device;

FIG. 2 is an example schematic of a pixel source controlled to produce a desired color mixture for display;

FIG. 3 is an example method for controlling, based on an input signal, a LED array in conjunction with a subtractive mask array with a corresponding passive nano-scale large gamut pixel array there-between;

FIG. 4 is an example graph illustrating common LED spectra with conventional full-width half maximums (FWHM) on the order of 100 nanometers (nm);

FIG. 5 depicts an example LED spectra for outputted primaries from a proposed waveguide with FWHM on the order of 10-20 nm; and

FIG. 6 is an example block diagram that illustrates a computer system upon which examples described may be implemented.

### DETAILED DESCRIPTION

A pixel source is provided that can include a light source, a waveguide receiving light emitted by the light source, and a subtractive mask overlaying the waveguide. The waveguide can include a plurality of cells, where each cell outputs a primary color from the light source. The subtractive mask can be binary or dynamic in nature, and can also include a plurality of cells precisely overlaying the plurality of cells of the waveguide. For binary arrangements, each of the plurality of cells of the subtractive mask can be (i) de-asserted to transmit the primary color, or (ii) asserted to block the primary color. For dynamic arrangements, each of the plurality of cells is configured for variable optical opacity. In such arrangements, a subtractive mask controller can vary the opacity of each cell in the dynamic subtractive mask such that the penetrability of the corresponding primary color is dynamic. Thus, a given cell in the dynamic subtractive mask can vary in opacity from totally opaque, in which the primary color is completely blocked, to totally transparent, in which the primary color is completely transmitted. Accordingly, the pixel source can further include a controller, or control input from a controller, to vary the opacity of each of the plurality of cells of the binary mask to output color points of primary colors transmitted through the cells of the subtractive mask. The outputted color points can then be interpolated and “half-toned,” or dithered, in order to produce a single pixel of a visual presentation.

Display devices known in the art include cathode ray displays which typically utilize three electron guns representing spectral peaks for red, green, and blue. Using a reference input video signal, the intensity of each of the three electron beams can be controlled to output a visual presentation. Alternatively, liquid crystal displays (LCD) typically utilize, at a pixel level, two transparent electrode plates with a nematic liquid crystal there-between, sandwiched between two polarizers (one parallel and one perpendicular). Likewise, surface-mount LED displays typically utilize, on a pixel level, an arrangement of three LEDs or a single RGB LED that output wide-band spectral peaks for red, green, and blue. Similar to an electron beam arrangement, the intensity of each LED can be controlled to output a color mixture for the represented pixel. An array of such light sources can be arranged to produce a visual presentation.

In contrast to the foregoing examples described, a display device is provided herein that includes light sources to emit light through an array of large gamut pixels. Such large gamut pixels may be manufactured or imprinted on a micron or nano-scale (e.g., a 100-500 nm scale). Each large gamut pixel in the array can ultimately represent a single pixel of a visual presentation. Furthermore, each large gamut pixel in the array can include a plurality of cells, or primary sub-pixels, where each primary sub-pixel is arranged to modulate the light source to output a narrow-band primary color such that one primary color is outputted for each primary sub-pixel. Modulation of the light source to output narrow-band primary colors may be performed using a grating having a selected length, width, orientation, pitch, and/or duty cycle to modulate the light source to output the desired wavelength corresponding to the desired primary. For a detailed explanation regarding gratings and directional backplanes to modulate light, reference is made to PCT Application Publication No. WO2013162609, entitled “Directional Pixel for use in a Display Screen.”

The color outputs for every large gamut pixel can be affected by a subtractive mask, also having a plurality of cells arranged to precisely overlay the sub-pixels of each individual waveguide. The subtractive mask can be dynamic in nature in that each cell can be controlled to have variable opacity. Thus, the sub-pixel on which a subtractive mask cell overlays, can have its outputted primary color blocked when the mask cell is fully opaque, transmitted through the subtractive mask when the mask cell is fully transparent, or partially transmitted when the mask cell has a varied opacity. Ultimately, on a micron or nano-scale (pixel level), the resultant transmitted light through the large gamut pixel and subtractive mask is comprised of a number of primary colors, the convex combination of which (interpolated and dithered) is a perceived secondary color. Accordingly, the disclosed display device can utilize the effect of Halftone Area Neugebauer Separation (HANS) on a pixel level in order to produce a macro-scale visual presentation of inimitable resolution and exceptional color gamut. Thus, for each given cell (single cell combination of a sub-pixel on the large gamut pixel and a cell of the subtractive mask), the wide-band light source is modulated to output a primary color with a brightness dependent on the opacity of the subtractive mask cell. For each given large gamut pixel and subtractive mask combination, a plurality of primary color points is outputted in accordance with the above. This plurality of primary color points can be distributed over a given unit of area, via dithering, to produce the desired secondary.

As used herein, a “visual presentation” can be any visual representation corresponding to an input signal. For example, the input signal can be associated with a stored image on a computing device. Accordingly, the visual presentation can be a displayed representation of the stored image on the display device. Alternatively, the visual presentation can correspond to a dynamic representation corresponding to a dynamic input signal. Such a dynamic input signal can be associated with real-time display of a video, a real-time computer monitor output, a mobile device output, and the like. Alternatively, a static visual presentation can be associated with an “emissive/backlit print,” instead of a dynamically displayed output. Accordingly, a binary subtractive mask array can be printed overlaying the large gamut pixel array and then appropriately connected to light sources. Accordingly, the visual presentation can be a displayed video or real-time output corresponding to user interactions on a keyboard, controller, etc., or a single, backlit static image produced by a printed subtractive mask and dithered output. The visual presentation can be composed of any number of pixels, each of which corresponds to a color, a plurality of colors, and/or a secondary color comprised of a combination of a plurality of primary colors.

As used herein, a “primary” or “primary color” is any modulation of an existing light source with controlled peak emission and controlled FWHM. Furthermore, for efficiency purposes, a corresponding unmodulated light source is presumed to have sufficient energy at a chosen peak wavelength and chosen FWHM to produce such primaries. Furthermore, as used herein a “secondary” is defined to be any convex combination, or dithered combination, of the primaries. Accordingly, a secondary may be a solid color composed of an optically averaged combination of primary colors. Or, the secondary may be a spectrum comprising the primary colors composed of weighted averages of each of the outputted primaries.

Among other benefits, examples described herein achieve a technical effect in which a displayed visual presentation can be provided with a larger color gamut achieved through implementation of disclosed examples. Accordingly, examples such as described utilize large gamut pixels to sharpen wide-band light source(s) and subtractive masking to output visual presentations with larger color gamut. By modulating the wide-band light source(s) to produce individual narrow-band light sources, larger color gamut output is achievable as compared to more conventional approaches that rely on intensity variation of wide-band light sources.

Examples described herein provide that methods, techniques, and actions performed by a computing device are performed programmatically, or as a computer-implemented method. Programmatically, as used herein, means through the use of code or computer-executable instructions. These instructions can be stored in a single or multiple memory resources of the computing device. A programmatically performed step may or may not be automatic.

Examples described herein can be implemented using programmatic modules or components of a system. A programmatic module or component can include a program, a sub-routine, a portion of a program, or a software component or a hardware component capable of performing stated tasks or functions. As used herein, a module or component can exist on a hardware component independently of other modules or components. Alternatively, a module or component can be a shared element or process of other modules, programs, or machines.

Furthermore, examples described herein may be implemented through the use of instructions that are executable by a processor. These instructions may be carried on a computer-readable medium. Machines shown or described with figures below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices, or tablets), and magnetic memory. Computers, terminals, and network enabled devices are examples of machines and devices that utilize processors, memory, and instructions stored on computer-readable mediums. Additionally, examples may be implemented in the form of computer-programs, or a non-transitory computer usable carrier medium capable of carrying such a program.

### Large Gamut Pixel and Subtractive Masking

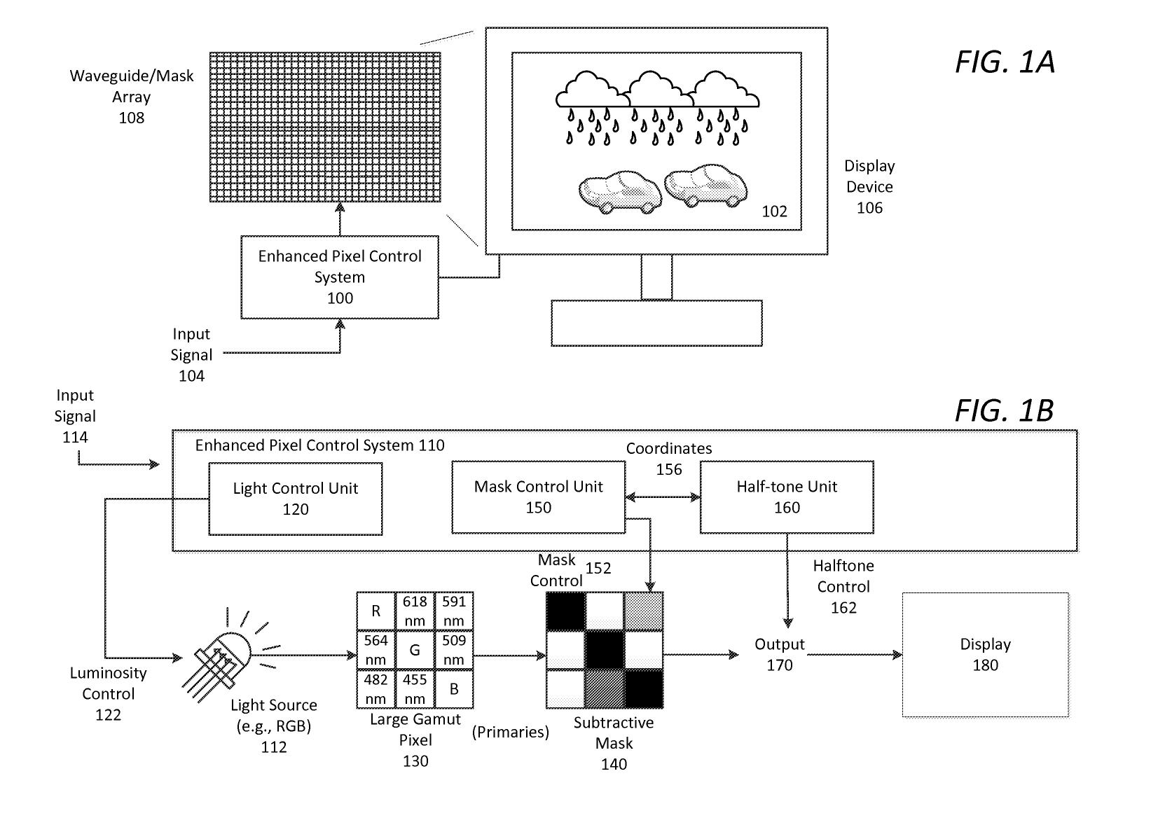

FIG. 1A is an example of a display device with a large gamut pixel/subtractive mask array controlled by an enhanced pixel control system. The display device 106 can include a single light source or multiple light sources, which can comprise a backlight for the display device 106, or an array of light sources to ultimately produce a visual presentation 102 on the display device 106. The display device 106 can be any type of monitor, such as a computer monitor, a television, a mobile device display, large scale LED displays, a theater screen, and the like. Furthermore, the display device 106 can ultimately output visual presentations 102 to be projected onto a display screen of the display device 106.

A large gamut pixel/mask array 108 can be included to receive light from a light source of the display device 106 and output a variety of narrow-band primary colors. Both the peak wavelength and FWHM can be controlled by a respective large gamut pixel. Accordingly, each large gamut pixel includes a plurality of cells, or primary sub-pixels, that individually output a respective primary color.

The large gamut pixel/mask array 108 can be a single array composed of a large gamut pixel array with a subtractive mask array precisely overlaying the large gamut pixel array. For example, each large gamut pixel in the large gamut pixel/mask array 108 can have a corresponding subtractive mask precisely disposed thereon, as discussed in detail below.

The large gamut pixel/mask array 108 itself can overlay a light source of the display device. The light source can be a backlight comprising a single or multiple lights, or alternatively a light source array (e.g., LED array), incorporating any number of individual lights. For example, a LED light source array can be comprised of thousands of individual RGB LED light sources, each outputting wide-band light and representing a single pixel of a visual presentation. The large gamut pixel/mask array 108 can receive the wide-band light emitted from such a light source, and output precise, narrow-band primary colors.

An enhanced pixel control system 100 can be included to control the large gamut pixel/mask array 108 and ultimately output the visual presentation 102 such that each pixel in the visual presentation 102 comprises a precise secondary color or spectrum composed of a convex combination of outputted narrow-band primary colors from a representative large gamut pixel/mask. For example, each large gamut pixel/mask in the large gamut pixel/mask array 108 outputs narrow-band color points, which are half-toned to produce a secondary color or spectrum representing a pixel in the visual presentation 102. Additionally or as an alternative, the narrow-band color points can be weighted over the space of a single pixel on the visual presentation 102 to produce a blended spectrum of the primaries. In such variations, the pixel is not required to comprise a single uniform secondary color, but rather may be comprised of optimized half-toned “sub-pixels” to provide larger color gamut for the visual presentation 102.

As an example, an individual large gamut pixel in the array 108 can include a number of primary sub-pixels (e.g., 3×3=9 sub-pixels) each outputting a spectral primary. The corresponding subtractive mask overlaying the large gamut pixel includes the same number of cells, each overlaying a corresponding primary sub-pixel. For 3×3 arrangements using a binary subtractive mask, there are 512 possible primary color combinations outputted through the subtractive mask. Each cell of the binary subtractive mask overlaying the large gamut pixel can have two states, (i) transparent, to transmit the respective primary color, or (ii) opaque, to block the respective primary color.

Thus, for a desired secondary color output, each cell of the binary mask is either asserted or de-asserted to block or transmit its respective primary. As an example, for the desired secondary color output, five cells in the binary subtractive mask may be asserted to block their respective primaries, allowing the remaining four to output their respective primaries. The outputted color points are interpolated, in that coordinates for each of the four color points can be computed in relation to the 3×3 grid comprising the binary subtractive mask. According to the coordinates, the four transmitted primaries are dithered to produce the desired secondary, which may be a solid average combination of the four primaries, or a spectrum of colors composed of weighted averages to the four primaries.

For arrangements using a dynamic subtractive mask, the opacity of each cell can be controlled so that the intensity, or brightness, of each of the four primary color points outputted through the subtractive mask can be controlled. Accordingly, the dithered secondary may be comprised of any combination, averaged or weighted, of the luminosity-controlled primaries.

In variations, the enhanced pixel control system 100 can receive an input signal 104 corresponding to the visual presentation 102. The input signal 104 can represent a single static image or a dynamic visual presentation (e.g., electronic computing output, video output, etc.). The enhanced pixel control system 100 can process the input signal 104 to manipulate the large gamut pixel/mask array 108 in order to project the visual presentation on the display device 106.

The input signal 104 can provide data or instructions regarding color that is to be outputted, which, for any given image or frame corresponding to the input signal, can include thousands, hundreds of thousands, or even millions of differing colors which are implausible to exactly reproduce. Ideally, the visual presentation 102 would include an exact replication of such color data or information from the input signal 104. However, since finite light sources must be used to approximate such color data (e.g., RGB sources), optimization of these finite light sources is performed to produce as accurate a visual presentation as possible according to the input signal 104. As discussed below with respect to FIG. 1B, a large gamut pixel array may be utilized for higher order optimization of such finite light sources to more precisely reproduce such color data according to the input signal 104.

FIG. 1B is an example schematic depiction of a pixel source for a display device. In the below discussion of FIG. 1B, reference may be made to like reference characters representing various features of FIG. 1A for illustrative purposes. Referring to FIG. 1B, an enhanced pixel control system 110 of the display device 106 receives an input signal 114 representing a static or dynamic visual presentation 102. The enhanced pixel control system 110 controls the entire large gamut pixel/mask array 108, which itself is comprised of any number of individual large gamut pixel/masks. Accordingly, each individual large gamut pixel/mask in the large gamut pixel/mask array 108 is controlled by the enhanced pixel control system 110. Such individual large gamut pixel/masks can represent a single pixel of the outputted visual presentation 102.

The light source 112 can be a white LED, a plurality of LEDs (e.g., in a RGB or RGBW arrangement), a RGB LED, a RGBW LED, an array of the foregoing, and the like. The light source 112 can also be an “off-the-shelf” wide-band RGB LED. The light source 112 can further comprise a phosphor-base LED, an organic LED (OLED), a quantum dot LED (QDLED), or various other miniature, mid-range, and/or high-powered LEDs, or a laser source, such as an RGB laser system.

A light control unit 120 can be included to control the light source 112. In response to the input signal, the light control unit 120 can operate the light source 112 using, for example, a luminosity control signal 122 to produce a continuous white light, such as for white LED light source or mixed RGB LED light source arrangements. In such examples, the light control unit 120 can produce constant luminosity for each light source 112 to be modulated to aid in the projection of the final, high quality visual presentation 102 with precise color fidelity and controlled spectral emission(discussed below).

Light emitted from the light source 112 is passed through a large gamut pixel 130, of the large gamut pixel/mask array 108, which modulates the wavelength of the light source 112 to produce narrow-band primary colors (primaries). For example, the light source 112 can be an off-the-shelf RGB LED producing common light with a FWHM on the order of 100 nm. Such a wide-band light source 112 has a relatively low chroma which has an ultimate effect of limiting color gamut and metamerism. Thus, when the emitted light is passed through the large gamut pixel 130, the wavelength(s) of the light can be modulated to produce a plurality of narrow-band primaries with FWHM on the order of 10-20 nm, resulting in much sharper spectral emissions resulting in significantly higher chroma far exceeding that of the wide-band light source 112.

To produce a respective primary, for each sub-pixel, a grating can be used to scatter the light source 112 to produce the desired primary having a desired wavelength. For example, the grating for each sub-pixel can have a selected grating length, width, orientation, pitch, and/or duty cycle to modulate the light source to output the desired wavelength corresponding to the desired primary. Due to the nature of the grating, the outputted primary can be directional in nature and have an angular spread. Accordingly, a diffusing screen may be included to redirect the outputted primary in order to provide discrete color points for interpolation and dithering.

The large gamut pixel 130 can include a plurality of cells, each to modulate the emitted light at a different wavelength to produce its own primary. For example, with reference to FIG. 1B, the individual large gamut pixel 130 can be in the form of a 3×3 grid with nine unique cells each outputting a unique narrow-band primary. Examples include a large gamut pixel 130 with a top left to bottom right configuration with nine primaries having respective peaks at or around 660, 630, 600, 570, 540, 510, 480, 450, and 420 nm. The example of FIG. 1 depicts a large gamut pixel 130 modulating the light emitted from the light source 112 at wavelengths ranging from deep red (˜660-680 nm) to deep blue (˜400-420 nm). As such, wide-band light that is passed through such a large gamut pixel 130 will be outputted as nine distinct, narrow-band primaries with exceptional high chroma.

The large gamut pixel 130 is optical in nature and can be produced on a micron, or even nano-scale. As such, a single nano-scale large gamut pixel 130 can represent a single pixel of the final visual presentation 102. Alternatively, multiple large gamut pixel arrangements can be combined to represent a single or multiple pixels. Furthermore, the large gamut pixel is not limited to a 3×3 grid of unique cells, but can have any number of cells arranged as a square (N×N grid) or rectangle (N×M), an ellipse with elliptical cells, a triangular grid, or any polygonal arrangement. As such, the large gamut pixel 130 may be arranged to produce as many narrow-band primaries as there are cells (unique modulators), which may further increase color gamut. Further still, each cell may modulate the emitted light to produce even higher chroma (e.g., <10 nm FWHM).

Alternative configurations for the large gamut pixel 130 are contemplated in which certain cells in the N×N grid of unique modulators do not modulate the light at all. For example, in the 3×3 arrangement, given an RGB LED light source 112, three diagonal cells may be configured as mere “unfiltered” guides to output the wide-band emission corresponding to spectral peaks in, for example, red, green, and blue from the RGB light source 112. Further variations can include four or more unfiltered cells depending on the light source 112 (e.g., RGBW LED).

According to examples, each light source 112 in a light source array, which itself can include hundreds, thousands, or any greater number of light sources (e.g., RGB LEDs), can include its own large gamut pixel 130. For example, the light source array can be precisely overlaid with a large gamut pixel array of individual large gamut pixels 130 such that each light source 112 in the light source array passes its emitted light through a single large gamut pixel 130. Accordingly, the output from the large gamut pixel array can be a white light, or potentially a different color blend, composed of a mixture of narrow-band primaries modulated through each cell of the large gamut pixel 130 in the large gamut pixel array. For example, an array of 3×3 large gamut pixels 130 precisely laid over the light source array and can produce a convex combination corresponding to a white light comprising a mixture of the nine narrow-band primaries with peaks as discussed above.

The outputted light from each of the large gamut pixel 130 can be affected by a subtractive mask 140 with cells that precisely overlay the cells of the large gamut pixel 130. For example, the 3×3 large gamut pixel 130 outputting nine distinct primaries can be overlaid by a 3×3 subtractive mask 140, with each cell directly overlaying a corresponding cell of the large gamut pixel 130. Accordingly, an array of subtractive masks can also be provided to precisely overlay the array of large gamut pixels (i.e., comprising the large gamut pixel/mask array 108), which itself can overlay the light source array.

For binary subtractive mask arrangements, each cell of the subtractive mask 140 can have two settings or modes associated with allowing transmission of the primary or blocking transmission of the primary. For example, each cell of the binary subtractive mask 140 can be controlled by the mask control unit 150, which can selectively assert (to block the primary) or de-assert (to transmit the primary) the cell accordingly to a mask control signal 152 applied to each cell in the subtractive mask 140. Thus, an individual subtractive mask cell may have an opaque mode and a transparent mode depending on whether it is asserted or de-asserted by the mask control unit 150.

A static visual presentation associated with an “emissive/backlit print” can be produced according to the above arrangement. As such, a static binary subtractive mask can be printed and overlaid on top of the array of large gamut pixels. The overall output from the large gamut pixel and subtractive mask is dithered to produce a single, backlit, static image.

Additionally or alternatively, each light source 112 in the light source array can include a corresponding large gamut pixel 130 and a subtractive mask 140 such that the wide-band emission is modulated into a plurality of narrow-band primaries, which are themselves either blocked or transmitted through the subtractive mask 140 in order to produce a color combination. The subtractive mask 140 can be dynamic, where each cell can be opacity controlled to output the narrow-band primary in varying luminosities. For example, the 3×3 large gamut pixel 130 can have any number of its outputted primaries either completely or partially blocked by the subtractive mask 140. In an example shown in FIG. 1B, only the upper-middle, middle-right, middle-left, and lower-left primaries are fully transmitted through the subtractive mask 140. Furthermore, the upper-right, and lower-middle cells have been asserted to have limited opacity such that their respective primaries are only partially blocked. Accordingly, the color combination of 618+509+564+482 nm unblocked primaries, and 591+455 nm partially blocked primaries, are transmitted through the subtractive mask 140. This primary combination can then be projected onto the screen of the display 180 in order to ultimately produce a single pixel with a secondary color or color combination corresponding to the mixture of the transmitted primaries.

Such an arrangement as shown in FIG. 1B, may be capable of producing 2̂9, or 512 “secondaries,” since nine primaries are outputted which can each either be transmitted or blocked by the subtractive mask 140. Furthermore, the mask control unit 150 can operate in a static and/or dynamic nature. Accordingly, the input signal 114 for the display device 100 can be representative of a single image, in which the mask control unit 150 can perform a single operation to output a single print image as the visual presentation 102. Additionally or as an alternative, the input signal 114 may be a video or other dynamic signal, in which the mask control unit 150 dynamically operates the subtractive mask 140 to output a different color combination for every frame of the video signal. In such arrangements, the mask control unit 150 can operate the entire subtractive mask array in order to output an exceptional visual presentation 102 with high-order color gamut.

The secondaries from the combined primaries transmitted through the subtractive mask 140 can be produced either passively (e.g., through lensing or projecting), or actively via interpolation and half-toning (e.g., interpolation in a Delaunay tessellated space followed by half-toning). Accordingly, the mask control unit 150 may be in communication with a halftone unit 160 to provide coordinates 156 of the asserted (and/or partially asserted) cells. Thus, the primary outputs can be interpolated and processed by the halftone unit 160, which can provide halftone control 162 (dithering) to the interpolated output 170 such that the convex combination, or the corresponding secondary, is perceived on the display 180. Thus, interpolating and half-toning the outputted primaries can be performed such that the XYZ tristimulus values correspond precisely with the photoreceptor response in the human eye.

As an example, each cell in the large gamut pixel 130 can be on the order of 25 microns in size. A high-definition pixel can be on the order of ˜100 microns, in which case, around a 4×4 tessellation area is available for each cell to be projected on the display screen. Thus, the output 170 of a primary color combination from the subtractive mask 140 can be interpolated and half-toned, via half-tone control 162 by the interpolation unit 160, and projected to ultimately produce a perceptually consistent or weighted secondary. The macro-combination of all such secondaries produced can result in the final visual presentation 102, which may be a static image, or single frame of a dynamic video output.

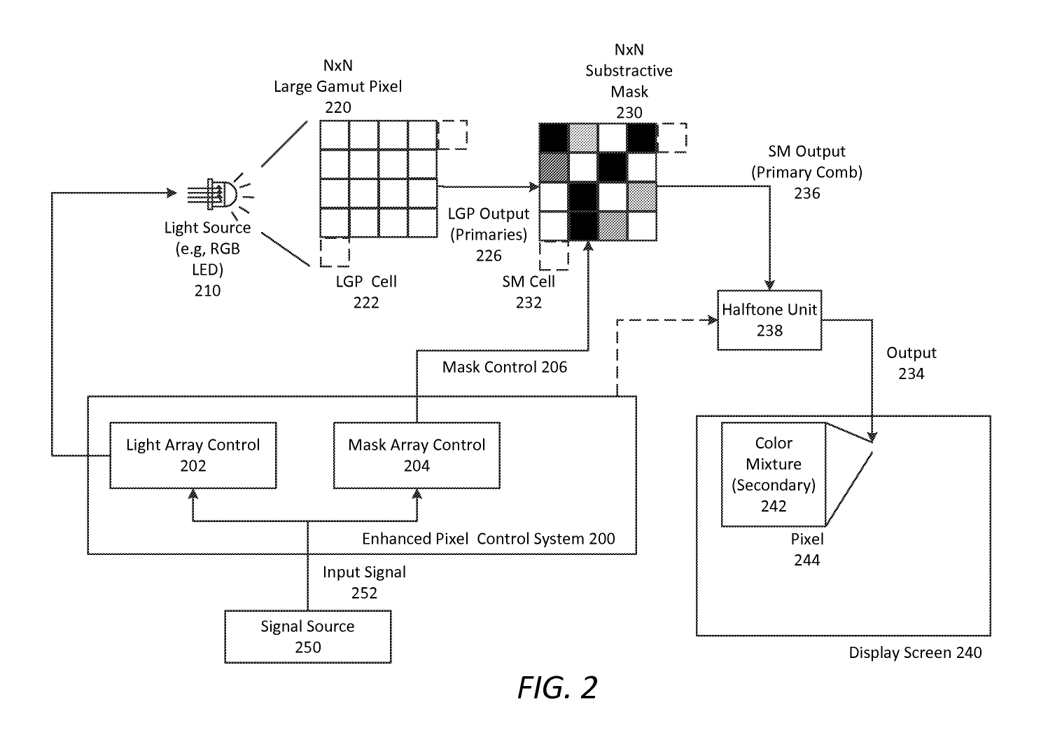

FIG. 2 is an example schematic of a pixel source controlled to produce a desired color mixture for display. Referring to FIG. 2, a signal source 250 transmits an input signal 252 which is received by the enhanced pixel control system 200 of a display device. The signal source 250 may be provided by a computing device such as a personal computer, an image, video, or other motion image player, a mobile device display source, a live feed from a visual capture device, and like sources.

The enhanced pixel control system 200 can process the input signal 252 to ultimately provide the visual presentation on a display screen 240 of the display device. In response to the input signal 252, a substantially continuous light source can be produced and modulated through an N×N large gamut pixel 220, where each large gamut pixel cell 222 (primary sub-pixel) outputs a unique primary. Thus, for a given input signal 252, the greater the number of sub-pixels in an individual large gamut pixel 220 corresponds to a greater optimization in reproducing an image or frame corresponding to the input signal 252.

As discussed above, the large gamut pixel output 226 can be a composition of narrow-band primaries which can further be affected by a N×N subtractive mask 230. Accordingly, each subtractive mask cell 232 in the N×N subtractive mask 230 can be controlled, via mask control signals 206 by a mask array control unit 204, to have two or more configurations, (i) transparent, (ii) variable opacity, or (iii) opaque. Thus, based on the input signal 252, the mask array control unit 204 can operate to produce a subtractive mask output 236 composed of a primary color combination, which can be interpolated and appropriately dithered by the halftone unit 238 (e.g., half-toned via HANS optimization techniques) to produce the desired secondary 242 based on the reference input signal 252.

As an example, the halftone unit 238 can be included in the enhanced pixel control system 200 to run HANS optimization logic in order to provide as accurate a pixel 244 as possible according to the input signal 252. Thus, the subtractive mask output 236 may be interpolated and processed by the halftone unit 238 to provide an output 234 corresponding to the displayed visual presentation. This output 234 may comprise half-toned primary color points outputted by the N×N subtractive mask 230, which result in a secondary comprising a distinct color mixture 242 of the outputted color points. Alternatively, the half-toned output 234 may represent a weighted spectrum of the outputted primaries 226.

The mask array control unit 204 can operate on the entire subtractive mask array overlaid on the large gamut pixel array, and for every frame of the visual presentation based on the input signal, asserts or de-asserts, or otherwise varies the opacity of, each individual cell 232 on every N×N subtractive mask 230 in the subtractive mask array. The mask control unit 204 can operate dynamically in conjunction with the halftone unit 238, in accordance with the input signal 252, to ultimately output a macro-scale visual presentation on a display screen 240 of the display device comprised of individual pixels 244 of high-quality secondaries 242.

Furthermore, a diffusing screen may be provided to diffuse the primary outputs from the subtractive mask 230 prior to dithering. For example, the modulated, narrow-band primaries outputted through transparent and/or partially transparent sub-pixels of a large gamut pixel 220 are often directional in nature, and therefore may require directional compensation. Accordingly, a diffusing screen may be disposed over the subtractive mask to redirect the outputted spectral primaries prior to interpolation, providing discrete color points for proper dithering.

### Methodology

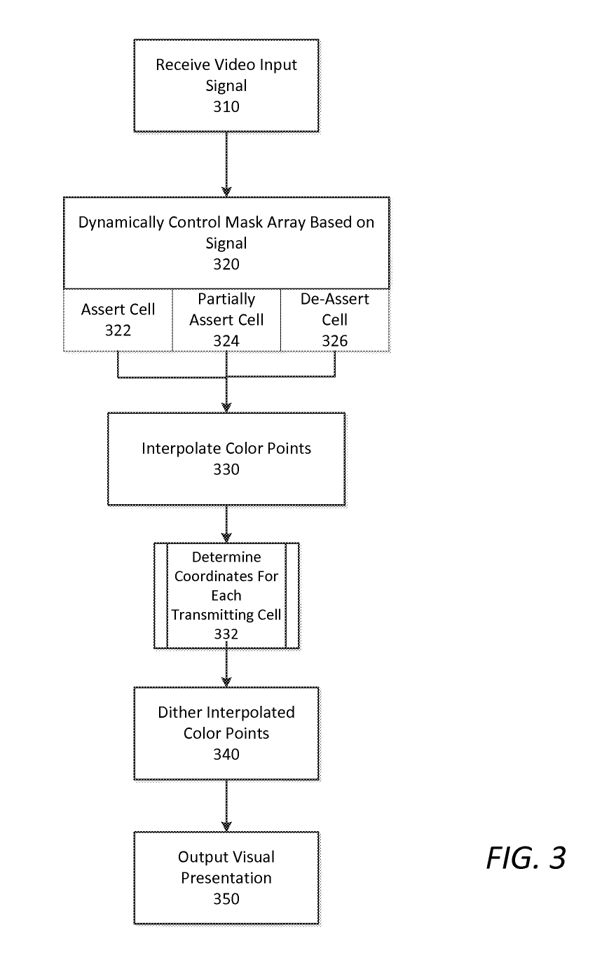

FIG. 3 is an example method for controlling, based on an input signal, a subtractive binary mask array with a corresponding passive nano-scale large gamut pixel array there-between. In the below discussion of FIG. 3, reference may be made to like reference characters representing various features of FIG. 2 for illustrative purposes. Referring to FIG. 3, an input signal 252 may be received by the enhanced pixel control system 200 (310). This input signal may represent, for example, a video feed representing a dynamic visual output.

Based on the input signal 252, the enhanced pixel control system 200 can trigger the mask array control unit 204 to dynamically control the subtractive mask array (320). Accordingly, each individual subtractive mask cell 232 can either be (i) asserted (322) to block the corresponding primary outputted by the large gamut pixel cell 222, (ii) de-asserted (326) to allow transmission of the corresponding primary through the subtractive mask cell 232, or partially asserted to control the variable opacity of the cell (324). The mask array control unit 204 can control every individual cell 232 in every individual N×N subtractive mask 230 of the mask array. The large gamut pixel output 226, comprising primaries, can be diffused with a diffusing screen prior to dithering.

The resultant macro-scale subtractive mask output 236 can be directly projected onto the display screen 240 as an outputted visual presentation (350). In such variations, the arrays (LED, large gamut pixel, and mask) can simply be offset from the display screen 240 by a gap or lens which allows the individual primaries outputted by the mask array to sufficiently synthesize in order to produce the desired secondaries for the visual output based on the input signal. Alternatively, the individual primaries outputted by the mask array can be interpolated (330). As such, the coordinates for each color point may be determined (332) and provided to the halftone unit 238 so that the individual color points can be dithered properly to produce the desired secondaries that comprise the visual presentation. As discussed above, a diffusing screen may be provided to diffuse the primary outputs from the subtractive mask 230 prior to dithering. Accordingly, any directional nature of the narrow-band primaries outputted through transparent and/or partially transparent sub-pixels of a large gamut pixel 220 can be compensated by the diffusing screen. Accordingly, a diffusing screen may be disposed over the subtractive mask to redirect the outputted spectral primaries prior to interpolation, providing discrete color points for proper dithering. Such dithering (340) may be performed through known methods, such as known methods of half-toning or lensing, in order to produce the convex combinations (secondaries) that comprise the final visual output. Accordingly, after the primary color points are dithered (340), the outputted color or spectral combination is projected onto the display screen 240, or outputted as a visual presentation representative of the input signal 252 (350).

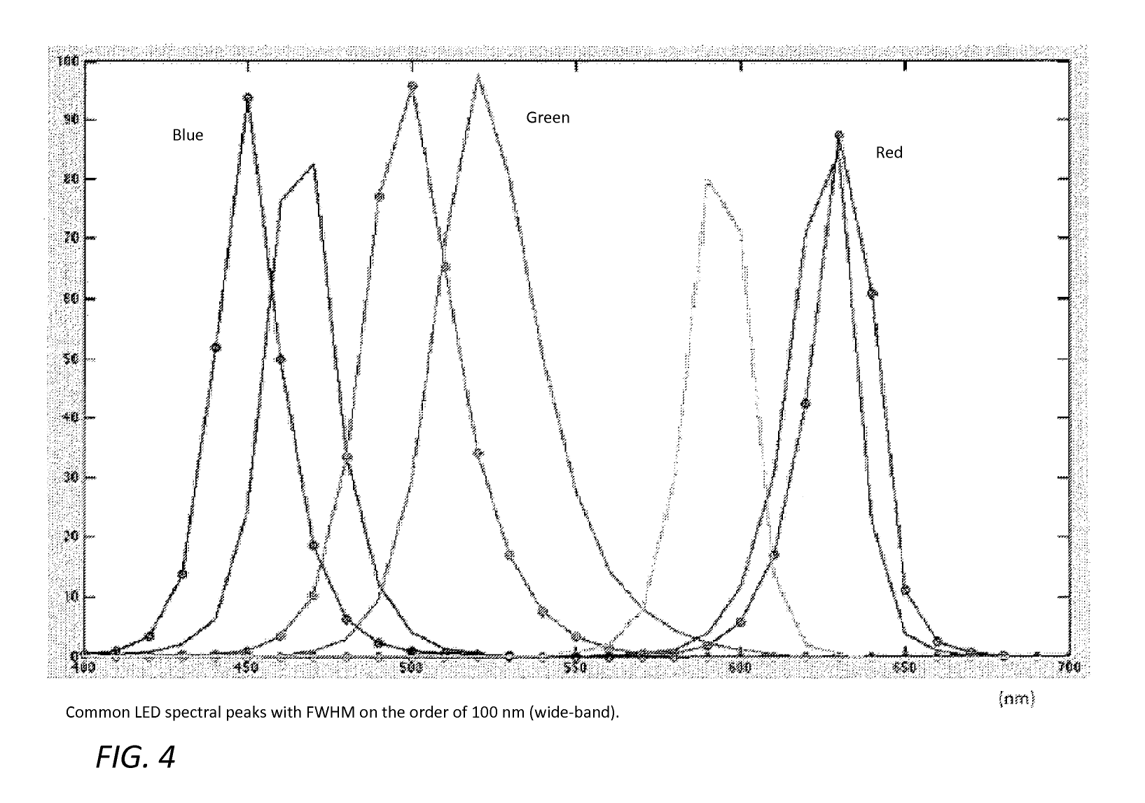

FIG. 4 is an example graph illustrating common LED spectra with conventional FWHMs on the order of 100 nm. As shown in FIG. 4, a common wide-band RGB LED will emit light with relatively poor chromaticity. The effect of such wide-band output is a limited color gamut due to invasive visual signals from other spectral peaks when varying the outputs corresponding to red, green, and blue peaks. Thus, significant overlap occurs due to the broad-band nature of typical off-the-shelf RGB LEDs limits the potential range in outputted color.

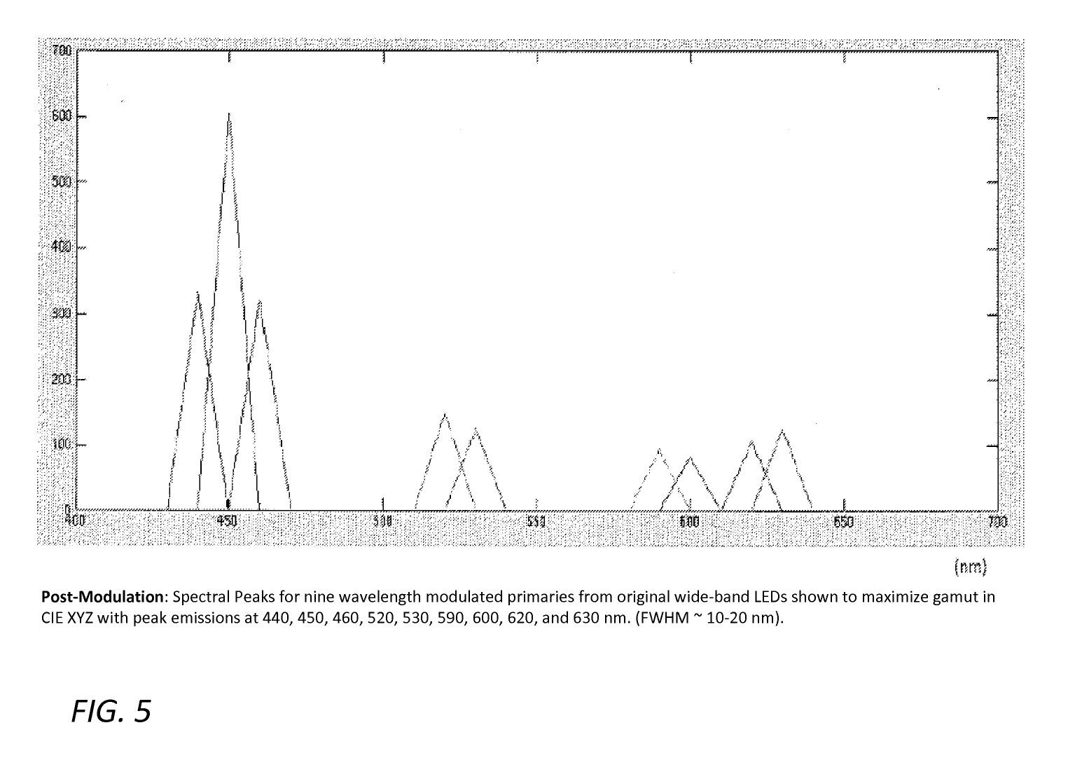

FIG. 5 depicts an example LED spectra for outputted primaries from a proposed large gamut pixel with FWHM on the order of 10-20 nm. As shown in FIG. 5, a typical wide-band RGB LED can be modulated through a 3×3 nano-scale large gamut pixel to produce nine distinct primaries with sharp spectral emission resulting in high purity and chroma. Distinct gaps are visible between spectral peaks corresponding to blue, green, and red respectively. Large gamut pixels can further distinguish primary peaks in order to further enhance color gamut.

### Hardware Diagram

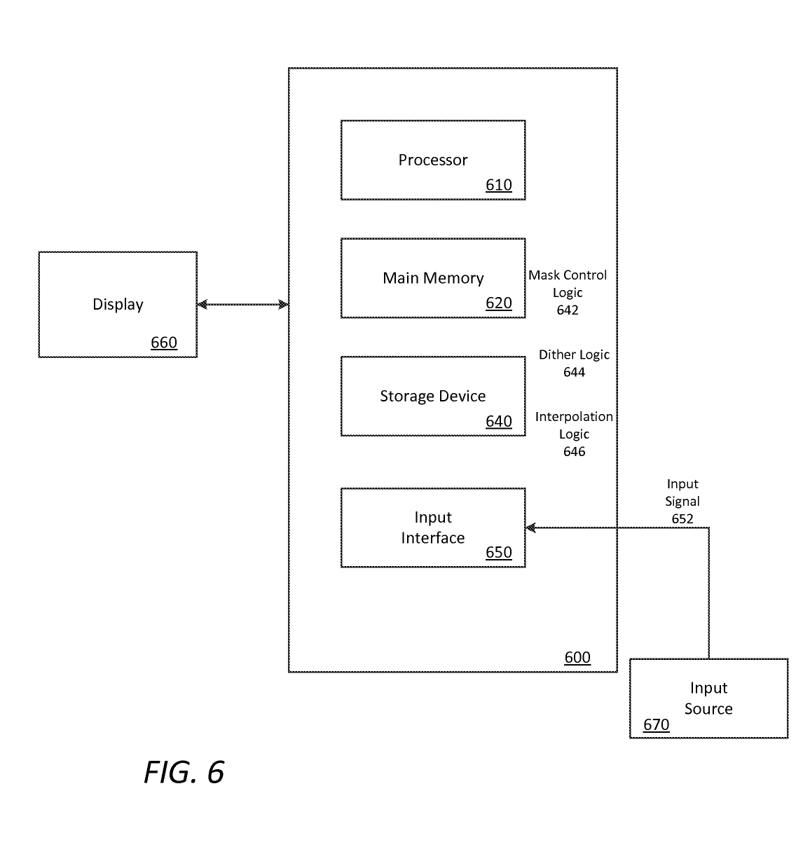

FIG. 6 is an example block diagram that illustrates a computer system upon which examples described herein may be implemented. For example, in the context of FIGS. 1A, 1B, and 2, the enhanced pixel control system 100, 110, 200 may be implemented using a computer system 600 such as described by FIG. 6. The system 100 may also be implemented using a combination of multiple computer systems as described by FIG. 6.

In one implementation, the computer system 600 can include processing resources 610, a main memory 620, ROM 630, a storage device 640, and a communication interface 650. The computer system 600 includes at least one processor 610 for processing information and a main memory 620, such as a random access memory (RAM) or other dynamic storage device, for storing information and instructions to be executed by the processor 610. The main memory 620 also may be used for storing temporary variables or other intermediate information during execution of instructions to be executed by the processor 610. A storage device 640, such as a magnetic disk or optical disk, can be provided for storing information and instructions. For example, the storage device 640 can correspond to a computer-readable medium that can include mask control logic 642, dither logic 644, and/or interpolation logic 646 for performing operations discussed with respect to FIGS. 1-3.

The input interface 650 can enable computer system 600 to communicate with an input source 670 (e.g., a computing device, video player, etc.) through use of an input link (wireless or wireline). The processor 610 can process the input signal 652 to control the subtractive mask array in order to output the visual presentation. The processor 610 can further process the input signal 652 to control the light source (e.g. RGB LED array), and further to half-tone the subtractive mask output to produce the visual presentation. Once the processor 610 receives the input signal 652, the processor 610 can execute the mask control logic 652, stored in the storage device 640, to control the large gamut pixel/mask array and the light source. Computer system 600 can also include a display 660 on which to output the visual presentation.

Examples described herein are related to the use of computer system 600 for implementing the techniques described herein. According to one example, those techniques are performed by computer system 600 in response to processor 610 executing sequences of instructions contained in main memory 620, such as the mask control logic 642. Such instructions may be read into main memory 620 from another machine-readable medium, such as storage device 640. Execution of the sequences of instructions contained in main memory 620 causes processor 610 to perform the process steps described herein. In alternative implementations, hard-wired circuitry may be used in place of or in combination with software instructions to implement examples described herein. Thus, the examples described are not limited to any specific combination of hardware circuitry and software.

Although illustrative examples have been described in detail herein with reference to the accompanying drawings, variations to specific examples and details are encompassed by this disclosure. It is intended that the scope of the invention is defined by the following claims and their equivalents. Furthermore, it is contemplated that a particular feature described, either individually or as part of an example, can be combined with other individually described features, or parts of other examples. Thus, absence of describing combinations should not preclude the inventor(s) from claiming rights to such combinations.

What is claimed is:

1. A pixel source for a visual presentation comprising:
a light source;
a large gamut pixel receiving light emitted by the light source, the large gamut pixel including a plurality of sub-pixels, each of the plurality of sub-pixels outputting a primary color;
a subtractive mask including a plurality of cells overlaying the plurality of cells of the large gamut pixel, each of the plurality of cells of the subtractive mask to be (i) de-asserted to transmit the primary color, or (ii) asserted to block the primary color; and
a controller to assert or de-assert each of the plurality of cells of the subtractive mask to output one or more color point of one or more of the primary colors transmitted through the de-asserted cells of the subtractive mask.

2. The pixel source of claim 1, further comprising a processing resource to dither the one or more color points to output an optical average of the one or more color points, the optical average representing a pixel of the visual presentation.

3. The pixel source of claim 1, wherein the controller operates to dynamically control the subtractive mask in response to a dynamic input signal.

4. The pixel source of claim 1, wherein the light source is a combination of wide-band red, green, and blue light emitting diodes (LEDs).

5. The pixel source of claim 1, wherein each of the plurality of cells of the subtractive mask has variable opacity, and wherein the controller further operates to partially assert one or more of the plurality of cells of the subtractive mask such that the partially asserted cells have partial opacity to partially transmit the respective primary color.

6. A display device comprising:
one or more light source;
an array of large gamut pixels disposed over the one or more light sources, each respective large gamut pixel receiving light emitted by the one or more light source and including a plurality of sub-pixels, each sub-pixel of the respective large gamut pixel modulating the received light to output a narrow-band primary color;
an array of subtractive masks disposed over the array of large gamut pixels, each subtractive mask including a plurality of cells overlaying the plurality of sub-pixels of the respective large gamut pixel, each cell of the subtractive mask being transparent to transmit the narrow-band primary color, or opaque to block the narrow-band primary color; and
a processing resource to dither one or more color points transmitted through the de-asserted cells of the subtractive mask to produce a visual presentation.

7. The display device of claim 6, wherein the array of subtractive masks is static to produce the visual presentation as a single backlit image.

8. The display device of claim 6, wherein the array of subtractive masks is dynamic such that each cell of the subtractive mask is to be (i) de-asserted to transmit the narrow-band primary color, or (ii) asserted to block the narrow-band primary color, the display device further comprising a controller to, in response to an input signal, assert or de-assert each cell of the subtractive mask to output the one or more color points comprising one or more of the narrow-band primary colors transmitted through the de-asserted cells of the subtractive mask.

9. The display device of claim 8, wherein the controller operates to dynamically control the array of subtractive masks in response to a dynamic input signal, and wherein the outputted visual presentation is a dynamic output corresponding to the dynamic input signal.

10. The display device of claim 8, wherein, prior to dithering the one or more color points, the controller operates to interpolate the one or more color points transmitted through the de-asserted cells of the subtractive mask.

11. The display device of claim 6, wherein the large gamut pixel is composed of a 3×3 grid of nine cells, and wherein each cell of the nine cells modulates the received light to output a unique narrow-band primary color.

12. The display device of claim 6, wherein the one or more light sources comprise one or more combinations of wide-band, red, green, and blue light emitting diodes (LEDs).

13. A computer-implemented method for controlling a display device to output a visual presentation, the method performed by one or more processors and comprising:
receiving an input signal corresponding to the visual presentation;
based on the input signal, controlling an array of subtractive masks overlaying an array of large gamut pixels, each subtractive mask disposed over a respective large gamut pixel and including a plurality of cells precisely overlaying a plurality of sub-pixels of the respective large gamut pixel, each sub-pixel outputting a narrow-band primary color, wherein controlling the array of subtractive masks includes, for each individual cell of the subtractive mask:
(i) asserting the individual cell to block the narrow-band primary color;
(ii) partially asserting the individual cell to partially transmit the narrow-band primary color; or
(iii) de-asserting the individual cell to transmit the narrow-band primary color;
wherein the one or more processors operate to output one or more color points comprising one or more of the narrow-band primary colors transmitted through the de-asserted and the partially asserted cells of the subtractive mask.

14. The computer-implemented method of claim 13, wherein the input signal is a dynamic input signal, and wherein the one or more processors operate to dynamically control the array of subtractive masks in response to the dynamic input signal to produce a dynamic output as the visual presentation.

15. The computer-implemented method of claim 13, further comprising interpolating and dithering the one or more color points to produce a secondary color representing a pixel in the visual presentation.
